(19) United States
(12) Patent Application Publication
(10) Pub. No.: US 2009/0225045 A1
(43) Pub. Date: Sep. 10, 2009

(54) Touch panel and display using the same

(75) Inventors: Chung-Wei Liu, Hsin-Chu (TW); Wei-Chen Tsai, Hsin-Chu (TW); Shih-Yu Wang, Hsin-Chu (TW)

Correspondence Address: BACON & THOMAS, PLLC, 625 SLATERS LANE, FOURTH FLOOR, ALEXANDRIA, VA, 22314-1176, US

(73) Assignee: AU OPTRONICS CORP., Hsin-Chu (TW)

(21) Appl. No.: 12/081,260

(22) Filed: Apr. 14, 2008

(30) Foreign Application Priority Data
Mar. 5, 2008 (TW) 97107743

(51) Int. Cl. G06F 3/041

(52) U.S. Cl. 345/173

(57) ABSTRACT

A touch panel includes a first base having a first portion and a second portion; a first electrode disposed on the first base; a second base opposite to the first base; a second electrode disposed on the second case; and a sealant substantially disposed on the boundary of the first base to connect the first base and the second base, wherein at lease a part of the second portion is located between active area and the sealant, and the thickness of the second portion is smaller than that of the first portion.

This application claims the benefit of Taiwan Patent Application Serial No. 97107743, filed Mar. 5, 2008, the subject matter of which is incorporated herein by reference.

### BACKGROUND OF THE INVENTION

1. Field of the Invention

The present invention generally relates to a touch panel and display using the same, and especially relates to a high sensibility touch panel and display using the same.

2. Description of Related Art

In all kinds of the consumer electric product markets, portable products, such as personal digital assistant (PDA), mobile phone, Global Positioning System (GPS) and digital media player etc., broadly use touch panel for being an interface between machines and human beings. Because of demands for thin and light products, therefore, engineers try to use touch input style instead of traditional keyboards and mouse for product design. As a result, touch panels become one of the key components.

As shown in FIGS. 1A and 1B, FIG. 1A is a top view of a conventional touch panel (display), wherein a resistance touch type is taken for example, and FIG. 1B is a cross section view of the conventional touch panel along the line I-I′ shown in FIG. 1A. In FIG. 1B, touch type display 1 includes touch panel 10, liquid crystal display panel 12 and flexible printed circuit board 14 for connecting the touch panel 10 and the liquid crystal display panel 12. Touch panel 10 is disposed on the liquid crystal display panel 12. Adhesive 11 is used to combine the touch panel 10 and the liquid crystal display panel 12. Touch panel 10 includes glass bases 101, 102, upper electrode 103 disposed on the glass base 101, lower electrode 104 disposed on the glass base 102, sealant 109 assembled the glass bases 101, 102, liquid crystal layer 108 or other filler filled between the glass bases 101, 102, and conductor 105 connected with lower electrode 104. Liquid crystal display panel 12 includes glass bases 121, 122, sealant 123 used to assemble the glass bases 121, 122, liquid crystal layer 124 filled between the glass bases 121, 122, and spacers 125 disposed between the glass bases 121, 122 to support glass bases 121, 122 for forming a constant and suitable gap.

If finger 13 or other pressing tool presses the top surface of the glass base 101 of the touch panel 10, top electrode 103 corresponding to the pressed location will touch specific lower electrode 104, thereby coordinates of the touched location will be created. Then liquid crystal display panel 12 will show desired images in response to the data process conducted by the flexible printed circuit board 14 and control system (not shown) according to the coordinates.

When pressing the touch panel 10, as shown in FIGS. 1A and 1B, because area B1 of the glass base 101 which is adjacent to the cured/hardened sealant 109 is more difficult to deform than the area B2 which is located in the center of the glass base 101. Area B1 has bad sensibility. Users have to apply more enforce to press, even the worse, the area B1 may be out of order, therefore touch type display 1 cannot operate normally and quality or capability thereof decreases.

### SUMMARY OF THE INVENTION

Accordingly, the present invention is directed to a touch panel which has better sensibility.

An objective of the present invention is to increase the sensibility of the touch panel.

An objective of the present invention is to increase the sensibility of the location which is adjacent to the sealant.

In accordance with the above objectives and other objectives, the present invention provides a touch panel, a base of which including a first portion and a second portion, wherein at least one part of the second portion is substantially located between the active area and the sealant, and the thickness of the second portion is about smaller than that of the first portion.

In accordance with the above objectives and other objectives, the present invention provides a display, a base of which including a first portion and a second portion, wherein at least one part of the second portion is substantially located between the active area and the sealant, and the thickness of the second portion is about smaller than that of the first portion.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a top view of a conventional touch type display.

FIG. 1B is a cress section view along line I-I′ of the touch type display in FIG. 1A.

FIG. 2 is a conventional touch panel for test in an experiment of the present invention.

FIG. 3A is a top view of a touch type display of the first embodiment of the present invention.

FIG. 3B is a cress section view along line II-II of the touch type display in FIG. 3A.

FIG. 3C is an enlarge view of a partial part of the area B1 of the touch type display in FIG. 3A when finger is pressing the area B1 in normal force.

FIG. 4 is a cross section view of a touch type display of the second embodiment of the present invention.

FIG. 5 is a cross section view of a touch type display of the third embodiment of the present invention.

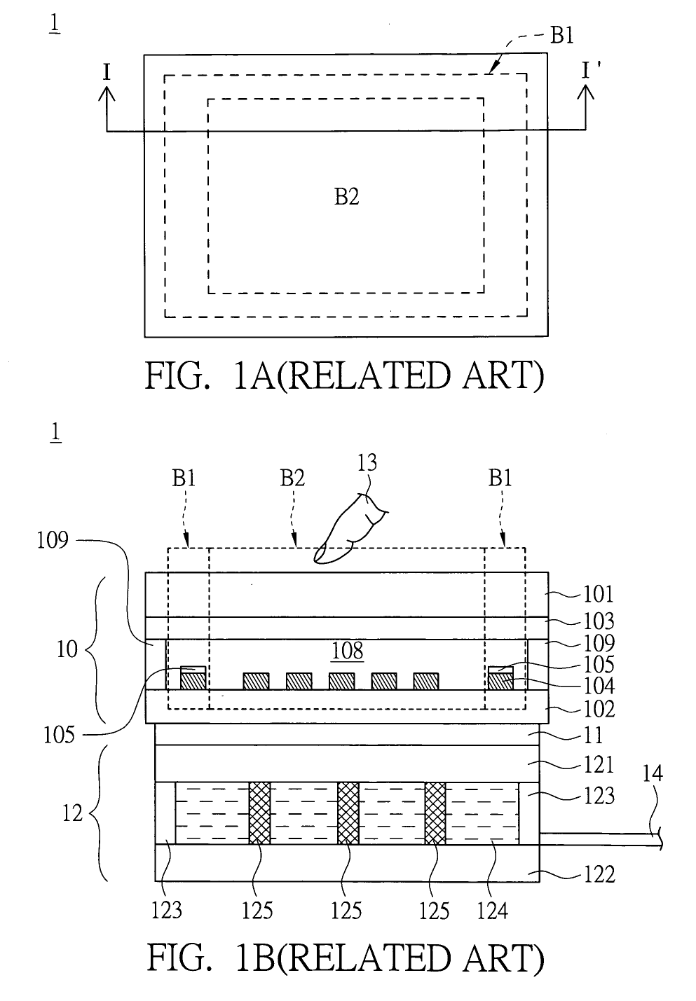

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

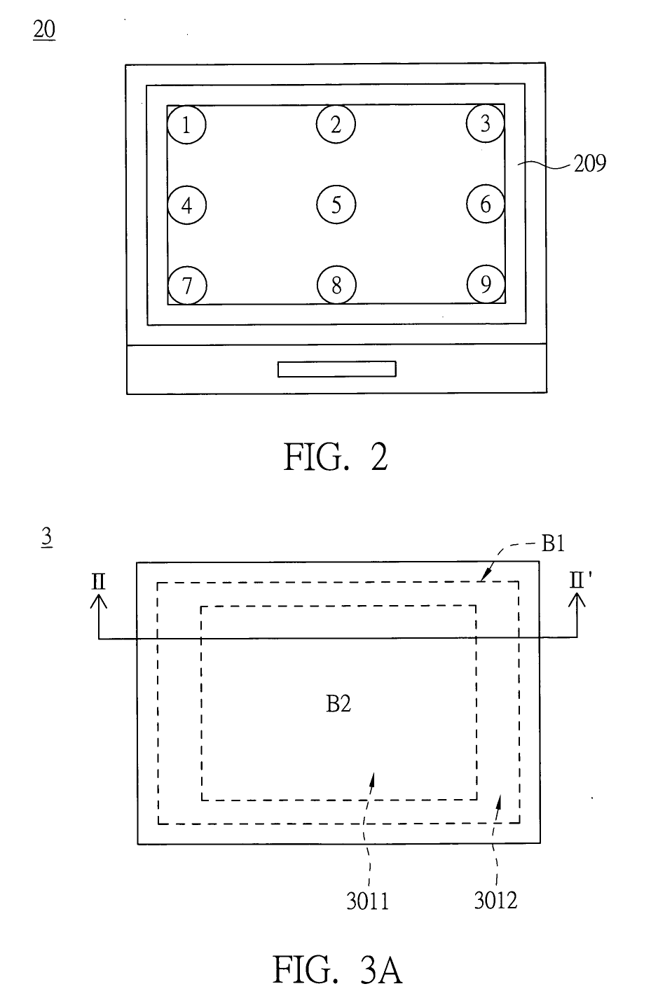

As shown in FIG. 2 and Table 1, FIG. 2 is a conventional touch panel for test in an experiment. Table 1 shows 9 locations of the touch panel in FIG. 2 and corresponding desired/sufficient force which can make sensing signal create.

TABLE 1

| | location | | | | | | | | | |
|---|---|---|---|---|---|---|---|---|---|---|
| | 1 | 2 | 3 | 4 | 5 | 6 | 7 | 8 | 9 | average |
| force(Kg) | 27 | 23 | 27 | 17 | 21 | 48 | 23 | 24 | 31 | 27 |

As shown in Table 1, locations 1, 3, 6 and 9 which are adjacent to sealant 209 need greater force than other locations, 27, 27, 48 and 31 KG, respectively. As we know, if we want locations which are near sealant 209 to sense, greater force must be applied. In other words, it is possible that locations which are near sealant 209 may be out of order or week sensibility. Therefore, when touch panel 20 is under operation, users have to pay more attention to provide greater force or do additional checks to see if the sensing signal is normal, so operative convenience and capability of touch panel 20 would be influenced.

Display or touch panel of the present invention is shown as following in detail and incorporated with FIGs for explaination.

### First Embodiment

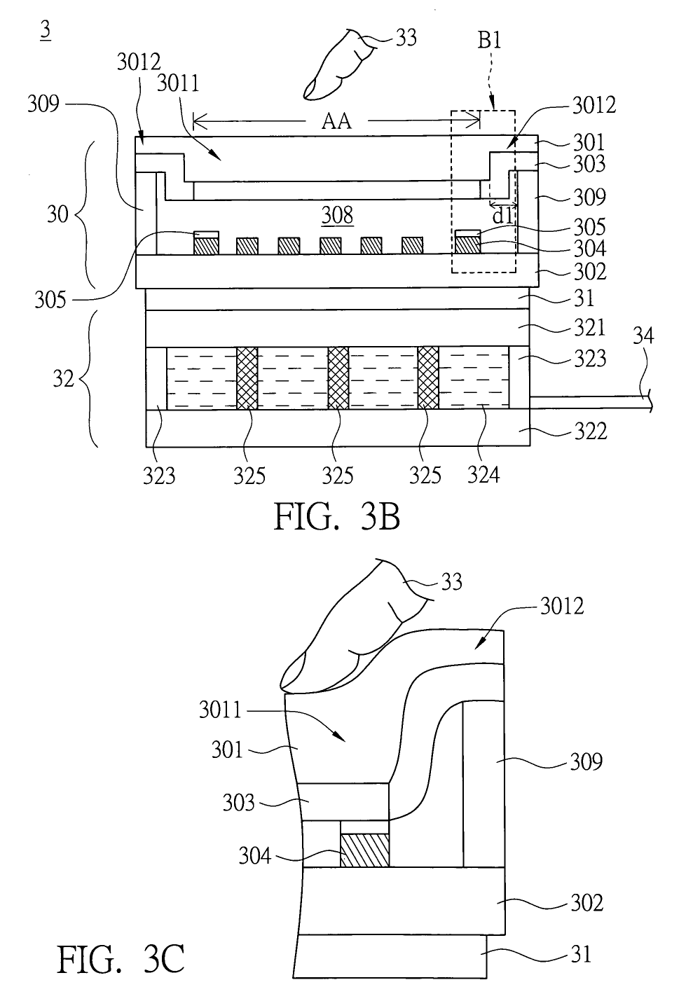

As shown in FIGS. 3A and 3B, FIG. 3A is a top view of the display according to the first embodiment of the present invention, and FIG. 3B is a cross section view along line II-II of the display in FIG. 3A according to the first embodiment of the present invention.

In FIG. 3B, touch type display 3 includes touch panel 30, liquid crystal display panel 32 and circuit board 34 for electrically connected between the touch panel 30 and the liquid crystal display panel 32. Circuit board 34 may be a flexible printed circuit board, for example. Liquid crystal display panel 32 is disposed beneath the touch panel 30. Adhesive 31 is used for connected the touch panel 30 and the liquid crystal display panel 32.

Touch panel 30 includes bases 301, 302; upper electrode 303 disposed on the base 301; lower electrode 304 disposed on the base 302; sealant 309 connected with the bases 301, 302; liquid crystal layer 108 or other filler filled between the bases 301, 302; and conductor 305 connected with the lower electrode 304. Materials of bases 301, 302 may be glass or quartz, for example. Materials of upper electrode 303 and lower electrode 304 may be transparent conductive materials, such as indium tin oxide (ITO), indium zinc oxide (IZO) or indium tin zinc oxide (ITZO), for example. Upper electrode 303 and lower electrode 304 define/form an active area AA. Active area AA is for showing images from liquid crystal layer 108 and/or for conducting most sensing function. Materials of sealant 309 may be light-curing glue or heat-curing glue. Base 301 includes first portion 3011 and second portion 3012. Second portion 3012 is located substantially around the first portion 3011. At least one part of the second portion 3012 is substantially located between the active area AA and sealant 309. Thickness of the second portion 3012 is about smaller than that of the first portion 3011. For example, thickness of the second portion 3012 may be about 60% to about 80%, and preferably, about 65% to about 75%. Distance d1 which is between the sealant 309 and the edge of the first portion 3011 is about 1 millimeter to about 1.5 millimeter, and preferably about 1.2 millimeter to about 1.5 millimeter.

Liquid crystal display panel 32 includes bases 321, 322; sealant 323 is for assembling bases 321 and 322; a liquid crystal layer 324 filled between the bases 321, 322; and spacers 325 for supporting bases 321 and 322 and for keeping constant and suitable gap therebetween.

FIG. 3C shows enlarge of a partial of area B1 when finger 33 apply normal/usual force to touch area B1 of touch type display 3. As shown, because thickness of the second portion 3012 is smaller than that of the first portion 3011, the deformable level of the second portion 3012 is greater than that of the first portion 3011. Even the touched area is adjacent cured/hardened sealant 309, touch panel 30 can successfully operate sensing function. In other words, upper electrode 303 therein can contact corresponding/specific lower electrode 304.

### Second Embodiment

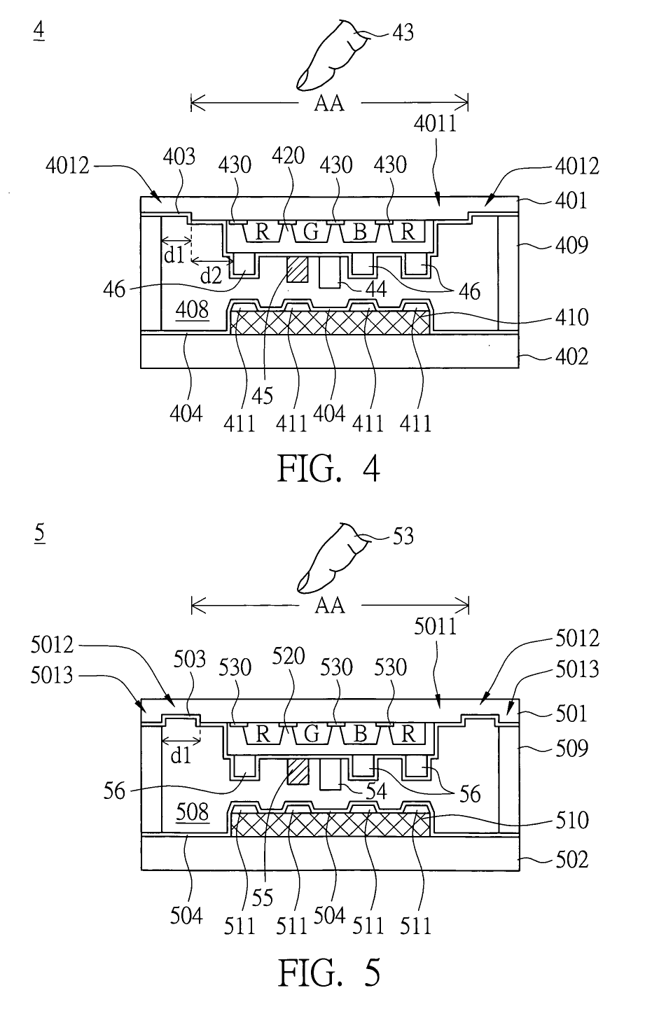

As shown in FIG. 4, FIG. 4 is a cross section view of the touch type display according to the second embodiment of the present invention.

Unlike the first embodiment, touch type display 4 is a display integrating touch panel and liquid crystal display panel. Thickness and weight thereof is smaller than that of the touch type display 3 of the first embodiment.

Touch type display 4 includes bases 401 and 402; upper electrode 403 disposed on the base 401; lower electrode 404 disposed on the base 402; sealant 409 connected with the bases 401 and 402; and liquid crystal layer 408 disposed between the bases 401 and 402. Materials of bases 401, 402 may be glass or quartz, for example. Materials of upper electrode 403 and lower electrode 404 may be transparent conductive materials, such as indium tin oxide (ITO), indium zinc oxide (IZO) or indium tin zinc oxide (ITZO), for example. Materials of sealant 409 may be light-curing glue or heat-curing glue.

Color filter array is disposed between the base 401 and the upper electrode 403. Color filter array includes light-shielding layer 430 and color resists, such as red resist R, green resist G and blue resist etc. Light-shielding layer 430 is substantially located between adjacent color resists. Insulating layer 420 is formed on the color filter array. Materials of the insulating layer 420 may be organic materials, for example. Bumps 46 and upper electrode 403 are formed on the insulating layer 420. Upper electrode 403 is formed on the bumps 46. Spacers include main-spacers 44 and sub-spacers 45 disposed between the bases 401 and 402 for supporting and keeping a constant or suitable gap. For example, number of sub-spacers 45 is about greater than that of the bumps 46, and number of the bumps 46 is about greater than that of the main-spacers 44.

Active device array 410 is disposed between the base 402 and lower electrode 404. Active device array 410 is a thin film transistor array, for example. Sensing pads 411 are formed on the active device array 410 or integrated with the active device array 410. Lower electrode 404 is formed on the sensing pads 411. Liquid crystal layer 408 is disposed between the upper electrode 403 and lower electrode 404.

Base 401 includes first portion 4011 and second portion 4012. Second portion 4012 is located substantially around the first portion 4011. At least one part of the second portion 4012 is substantially located between the active area AA and sealant 409. Thickness of the second portion 4012 is about smaller than that of the first portion 4011. For example, thickness of the second portion 4012 may be about 60% to about 80%, and preferably, about 65% to about 75%. Distance d1 which is between the sealant 409 and the edge of the first portion 4011 is about 1 millimeter to about 1.5 millimeter, and preferably about 1.2 millimeter to about 1.5 millimeter. Smallest distance d2 which is between the bump 46 and the edge of the first portion 4011 is about 500 micrometer to about 600 micrometer.

When finger 43 or other pressing tools presses the active area of the touch type display 4, because thickness of the second portion 4012 is smaller than that of the first portion 4011, the deformable level of the second portion 4012 is greater than that of the first portion 4011. Even the touched area is adjacent cured/hardened sealant 409, touch type display 4 can successfully operate sensing function. In other words, upper electrode 403 on the bump 46 therein can contact corresponding/specific lower electrode 404. Then coordinates of corresponding touched location can be created and touch type display 4 can display images thereafter.

### Third Embodiment

As shown in FIG. 5, FIG. 5 shows a cross section view of a touch type display according to the third embodiment of the present invention.

Unlike the first embodiment, touch type display 5 is a display integrating touch panel and liquid crystal display panel. Thickness and weight thereof is smaller than that of the touch type display 3 of the first embodiment.

Touch type display 5 includes bases 501 and 502; upper electrode 503 disposed on the base 501; lower electrode 504 disposed on the base 502; sealant 509 connected with the bases 501 and 502; and liquid crystal layer 508 disposed between the bases 501 and 502. Materials of bases 501, 502 may be glass or quartz, for example. Materials of upper electrode 503 and lower electrode 504 may be transparent conductive materials, such as indium tin oxide (ITO), indium zinc oxide (IZO) or indium tin zinc oxide (ITZO), for example. Materials of sealant 509 may be light-curing glue or heat-curing glue.

Color filter array is disposed between the base 501 and the upper electrode 503. Color filter array includes light-shielding layer 530 and color resists, such as red resist R, green resist G and blue resist etc. Light-shielding layer 530 is substantially located between adjacent color resists. Insulating layer 520 is formed on the color filter array. Materials of the insulating layer 520 may be organic materials, for example. Bumps 56 and upper electrode 503 are formed on the insulating layer 520. Upper electrode 503 is formed on the bumps 56. Spacers includes main-spacers 54 and sub-spacers 55 disposed between the bases 501 and 502 for supporting and keeping a constant or suitable gap. For example, number of sub-spacers 55 is about greater than that of the bumps 56, and number of the bumps 56 is about greater than that of the main-spacers 54.

Active device array 510 is disposed between the base 502 and lower electrode 504. Active device array 510 is a thin film transistor array, for example. Sensing pads 511 are formed on the active device array 510 or integrated with the active device array 510. Lower electrode 404 is formed on the sensing pads 511. Liquid crystal layer 508 is disposed between the upper electrode 503 and lower electrode 504.

Base 501 includes first portion 5011, second portion 5012 and third portion 5013. Second portion 5012 is located around the first portion 5011. Third portion 5013 is located around the second portion 5012. Second portion 5012 is substantially located between the active area AA and the sealant 509. Sealant 509 is disposed on the third portion 5013. Thickness of the second portion 5012 is about smaller than that of the first portion 5011. For example, thickness of the second portion 5012 is about 60% to about 80% of that of the first portion 5011, and preferably about 65% to about 75%. Distance d1 which is between the sealant 509 and the edge of the first portion 5011 is about 1 millimeter to about 1.5 millimeter, and preferably about 1.2 millimeter to about 1.5 millimeter. Thickness of the third portion 5013 is smaller than or equal to the first portion 5011.

When finger 53 or other pressing tools presses the active area of the touch type display 5, because thickness of the second portion 5012 is smaller than that of the first portion 5011 and third portion 5013, the deformable level of the second portion 5012 is greater than that of the first portion 5011. Even the touched area is adjacent cured/hardened sealant 509, touch type display 5 can successfully operate sensing function. In other words, upper electrode 503 on the bump 56 therein can contact corresponding/specific lower electrode 504. Then coordinates of corresponding touched location can be created and touch type display 5 can display images thereafter.

As shown, present invention provides a touch panel and touch type display. Using a base having two or more portions with different thickness. If the portion adjacent to the sealant has less thickness, sensibility therein can be almost as good as other sensing area. Therefore, when conducting a touch panel or touch type display, users can easily provide normal/usual force to touch the panel or display to successfully perform touch process. As a result, capability thereof can increase and operational stability or convenience can be better as well.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A touch panel comprising:
a first base including a first portion and a second portion;
a first electrode disposed on the first base;
a second base opposite to the first base;
a second electrode disposed on the second base, wherein the first electrode and the second electrode define an active area; and
a sealant substantially disposed on the boundary of the first base to assemble the first base and the second base, wherein at least one part of the second portion is substantially located between the active area and the sealant, and the thickness of the second portion is about smaller than that of the first portion.

2. The touch panel according to claim 1, wherein the thickness of the second portion is about 60% to 80% of that of the first portion.

3. The touch panel according to claim 1, wherein the first base further includes a third portion, the second portion being located between the first portion and the third portion, and the thickness of the third portion being equal to or smaller than that of the first portion.

4. The touch panel according to claim 3, wherein the sealant is located on the third portion.

5. The touch panel according to claim 1, wherein the sealant is located on the second portion.

6. The touch panel according to claim 1, further comprising a liquid crystal layer disposed between the first electrode and the second electrode.

7. The touch panel according to claim 6, further comprising a plurality of spacers disposed between the first electrode and the second electrode.

8. The touch panel according to claim 7, further comprising at least one bump disposed on the first portion of the first base, wherein the first electrode is disposed on the bump.

9. The touch panel according to claim 8, wherein the spacers include a plurality of main-spacers and a plurality of sub-spacers, the number of the sub-spacers being greater than that of the at least one bump, and the number of the at least one bump being greater than that of the main-spacers.

10. The touch panel according to claim 1, further comprising at least one bump disposed on the first portion of the first base, wherein the first electrode is disposed on the bump.

11. The touch panel according to claim 10, wherein the least distance between the at least one bump and the edge of the first portion is about 500 micrometer to about 600 micrometer.

12. The touch panel according to claim 1, further comprising:
a color filter array disposed between the first base and the first electrode;
an active device array disposed between the second base and the second electrode; and
a liquid crystal layer disposed between the first electrode and the second electrode.

13. The touch panel according to claim 1, wherein the sealant is not located on the first portion and the distance between the sealant and the edge of the first portion is about 1 millimeter to about 1.5 millimeter.

14. The touch panel according to claim 1, wherein the material of the first base is comprised of glass or quartz.

15. The touch panel according to claim 1, wherein the material of the first electrode is comprised of a transparent conductive material.

16. The touch panel according to claim 15, wherein the material of the first electrode is comprised of indium tin oxide (ITO), indium zinc oxide (IZO) or indium tin zinc oxide (ITZO).

17. The touch panel according to claim 1, wherein the material of the second electrode is comprised of a transparent conductive material.

18. The touch panel according to claim 17, wherein the material of the second electrode is comprised of indium tin oxide (ITO), indium zinc oxide (IZO) or indium tin zinc oxide (ITZO).

19. A display comprising:
a touch panel according to claim 1; and
a liquid crystal display panel disposed beneath and electrically connected to the touch panel.

20. The display according to claim 19, further comprising a circuit board electrically connected between the touch panel and the liquid crystal display panel.
